(19) United States
(12) Patent Application Publication
(10) Pub. No.: US 2003/0135723 A1
(43) Pub. Date: Jul. 17, 2003

(54) Method and device for processing interrupt signals

(76) Inventor: Bernd Illg, Eppingen (DE)

Correspondence Address: KENYON & KENYON, ONE BROADWAY, NEW YORK, NY, 10004, US

(21) Appl. No.: 10/313,389

(22) Filed: Dec. 6, 2002

(30) Foreign Application Priority Data
Dec. 7, 2001 (DE) 101 60 298.7

(51) Int. Cl. G06F 15/00

(52) U.S. Cl. 712/244

(57) ABSTRACT

In a method and a device for processing interrupt signals, upon the occurrence of an interrupt, a status of a counter is modified in predetermined fashion and the interrupt is inhibited as soon as the counter status assumes a definable value. A computer program and a computer program product are used to perform the method.

### CROSS-REFERENCE TO RELATED APPLICATIONS

The present application claims priority to Application No. 101 60 298.7, filed in the Federal Republic of Germany on Dec. 7, 2001, which is expressly incorporated herein in its entirety by reference thereto.

### FIELD OF THE INVENTION

The present invention relates to a method and a device for processing interrupt signals. The present invention furthermore relates to a computer program for performing the method.

### BACKGROUND INFORMATION

In motor vehicles, engine control units that receive input signals via a plurality of data lines and that output control signals via control lines are used to control mechanical and electrical or electronic sequences. For that purpose, calculation units (so-called controllers) provided in control units execute programs that process the incoming data, calculate and output control signals, and thus ensure reliable operation of the motor vehicle.

Upon the occurrence of specific external events, it is necessary to interrupt programs executing on the controller so that the external event may be reacted to properly. This purpose is served by program interrupts. These interrupts interrupt the normal program execution of the time-synchronous program and initiate execution of an interrupt program. If the signal is correct, this ensures that the frequency of interrupts is so low that the interrupt frequency is sufficiently small, and the interruptions in the normal program sequence therefore do not result in an impermissibly long program run time. If too many interrupts are triggered as a result of malfunctions, however, it may happen that the normal program sequence lasts too long. If a new request is present before execution of the interrupt program, the result of a malfunction may be that the normal program may no longer be processed.

It is therefore necessary to find a method that protects the interrupt processing function from malfunction-related interrupts.

German Published Patent Application No. 35 44 079 describes a method for processing interrupts in which, at the beginning of the interrupt, a counter is started and the interrupts are inhibited. After a certain time has elapsed, either an interrupt must be initiated in which the hardware interrupt is once again enabled, or the interrupt inhibition must be released in time-synchronous fashion if the time counter has elapsed. This method provides that the interrupts are always inhibited for a certain time, so there is no assurance that a suitable reaction to specific external events may occur at any time.

German Published Patent Application No. 43 19 881 describes a method for processing interrupt signals of an interrupt source. In the method described, after occurrence of an interrupt signal of the interrupt source, the main program is interrupted and the interrupt program is executed instead, further interrupt requests of the same interrupt source being inhibited upon initiation of processing of the interrupt program. Only interrupts within an interval defined by a lower and an upper limit value are recognized as permissible. These lower and upper limit values are definable as a function of operating parameters. In the method described, interrupts are first inhibited and then enabled again for a specific time window. This method provides that in the event of a sequence of two interrupts closely spaced in time, the second (possibly permissible) interrupt is not processed.

### SUMMARY

The method according to the present invention for processing interrupt signals provides that upon occurrence of an interrupt, a status of a counter is modified in predetermined fashion, and the interrupt is inhibited as soon as the counter status assumes a definable value.

This therefore may ensure, without a major load in the interrupt program section, that only a limited number of interrupts may be triggered in a defined time window. The interrupts may follow one another as closely as desired in time. The interrupts may therefore be located, and be executed, very close to one another in time. Overloading is prevented, however, since the number of interrupts in the time window is limited.

In an example embodiment of the present invention, the occurrence of an interrupt causes the counter status to be decremented. In this case the counter status may be initialized to an initial value once or always at specific points in time, and decreased by one unit at each occurrence of an interrupt.

In a cyclically invoked program section that represents a fixed time window, the maximum number of interrupts occurring in a time window is known. Upon execution of the cyclically invoked program section, firstly the interrupt is enabled and the counter is initialized to an initial value that reflects the maximum number of interrupts in the time window. As soon as an interrupt occurs, program execution is interrupted and the interrupt program is started. The counter status is decremented and may be compared to zero. As soon as the counter status equals zero, the interrupt is inhibited. This may mean that the interrupt program is immediately discontinued, or that it is completed and no further interrupt may be triggered in that time window. The result of this is that upon occurrence of an interrupt, normal program execution is not interrupted.

The device according to the present invention for processing interrupt signals may serve to perform the method described above. The device includes a calculation unit for processing programs and interrupt signals, and a counter whose status is modified in predetermined fashion upon occurrence of an interrupt. The counter is configured to inhibit the interrupt when a definable value is reached.

The computer program according to the present invention encompasses program code in order to perform all the steps of the method described. The computer program is performed on a computer or a corresponding calculation unit. This calculation unit may be integrated into an engine control unit.

The computer program product according to the present invention includes program code that may be stored on a computer-readable data medium. EEPROMs and flash memories, but also CD-ROMs, diskettes, hard disk drives, etc., may be used as suitable data media.

Example embodiments of the present invention are illustrated in the drawings and are explained below. It should be understood that the features described above and those described below may be used not only in the combination indicated but also in other combinations or alone without departing from the context of the present invention.

### BRIEF DESCRIPTION OF THE DRAWINGS

FIG. 1 schematically illustrates an example embodiment of a device according to the present invention.

FIG. 2 shows an example embodiment of a method according to the present invention as a flow chart.

### DETAILED DESCRIPTION

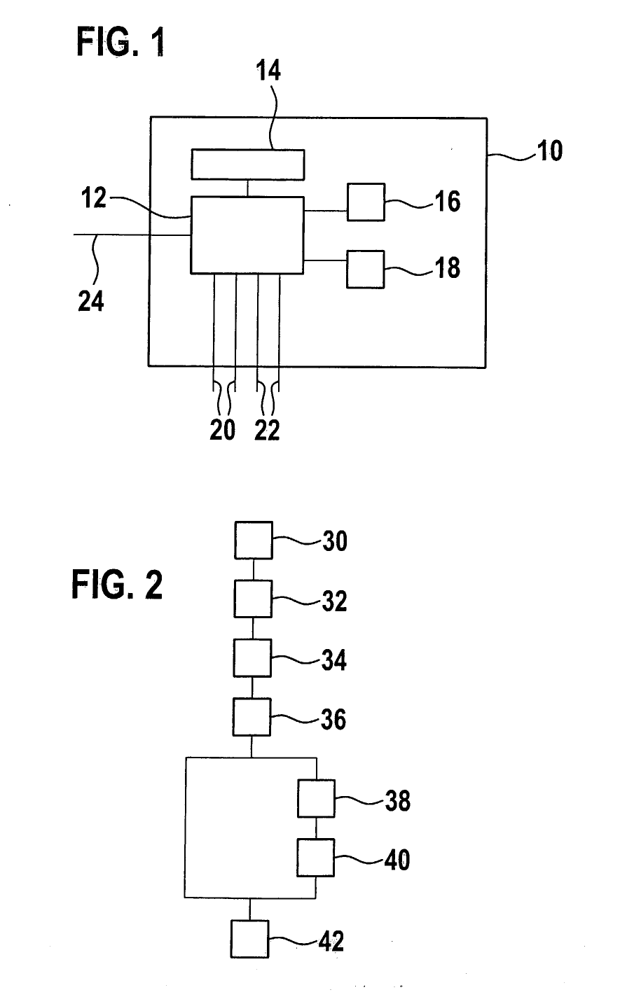

FIG. 1 schematically illustrates an engine control unit 10. Engine control unit 10 contains a calculation unit 12 (a “controller”), a counter 14, a program memory 16, and an interrupt program memory 18.

Engine control unit 10 receives information from sensors via two signal lines 20, and emits control signals to the outside via two control lines 22. Engine control unit 10 communicates with peripheral devices via control lines 22 and signal lines 20 in order to ensure dependable operation.

Also provided is an interrupt line 24 on which an interrupt signal is present when specific external circumstances exist. These circumstances may be, for example, malfunctions resulting from external influences.

Program sequences that are executed (e.g., cyclically) on calculation unit 12 are stored in program memory 16. These program sequences are interrupted as soon as an interrupt signal is present, and the interrupt program contained in interrupt program memory 18 is executed. At each execution of the interrupt program, the status of counter 14 is modified in predetermined fashion. As soon as the counter status assumes a definable value, the interrupt is inhibited, i.e., in the presence of an interrupt signal the interrupt program is not executed, and normal program execution is not interrupted.

FIG. 2 illustrates, with reference to a flow chart, the execution of an example embodiment of the method according to the present invention.

In a step 30, the program is executed on calculation unit 12. To begin with, in a step 32 the interrupt is enabled and in a step 34 the counter status is initialized to an initial value. The counter status represents an indicator of the maximum number of interrupts permitted in a time window.

Upon activation of the interrupt signal, in a step 36 program execution is interrupted if the interrupt is enabled; and in a step 38 the interrupt program is started. The interrupt program allows engine control unit 10 to react appropriately to the external event triggering the interrupt.

In the interrupt program, the counter status is decremented in a step 40. When the counter status reaches a value of zero, the interrupt is inhibited. After execution of the interrupt program, the interrupted program is continued in a step 42.

If an interrupt signal is present in step 36 and the check indicates that the interrupt is inhibited, the program is not interrupted; therefore no interrupt is triggered, and the interrupt program is not started.

Each time an interrupt signal is present in program step 36, the interrupt program is executed in step 38 only if the interrupt is enabled. If this is not the case, the program is not interrupted and the interrupt program is not executed.

Since the interrupt is enabled and the counter status is set to an initial value at the beginning of each program execution, it is possible to ensure that only a certain number of interrupts may be triggered in a time window. The interrupts may, however, occur arbitrarily close to one another in time. Only the number of interrupts in a time window is therefore limited, thereby ensuring dependable execution of the main program.

What is claimed is:

1. A method for processing an interrupt signal, comprising:
modifying, upon occurrence of an interrupt, a status of a counter in predetermined fashion; and
inhibiting the interrupt as soon as the status of the counter assumes a definable value.

2. The method of claim 1, further comprising decrementing the counter upon occurrence of the interrupt.

3. The method of claim 1, further comprising initializing the counter at specific points in time.

4. The method of claim 1, further comprising:
enabling the interrupt and initializing the counter;
upon occurrence of the interrupt, decrementing the counter; and
inhibiting the interrupt as soon as the counter is equal to zero.

5. A device for processing an interrupt signal, comprising:
a calculation unit configured for processing programs and interrupt signals; and
a counter having a status modifiable in predetermined fashion upon occurrence of an interrupt, the counter configured to inhibit the interrupt when a definable value is reached.

6. The device of claim 5, wherein the device is configured to perform a method for processing the interrupt signal, the method including the steps of:
modifying, upon occurrence of the interrupt, the status of the counter in predetermined fashion; and
inhibiting the interrupt as soon as the status of the counter assumes the definable value.

7. The device of claim 6, wherein the method includes decrementing the counter upon occurrence of the interrupt.

8. The device of claim 6, wherein the method includes initializing the counter at specific points in time.

9. The device of claim 6, wherein the method includes:
enabling the interrupt and initializing the counter;
upon occurrence of the interrupt, decrementing the counter; and
inhibiting the interrupt as soon as the counter is equal to zero.

10. A computer program comprising program code executable by one of a computer and a corresponding calculation unit, the program code configured to perform a method for processing interrupt signals, the method including:
modifying, upon occurrence of an interrupt, a status of a counter in predetermined fashion; and
inhibiting the interrupt as soon as the status of the counter assumes a definable value.

11. The computer program of claim 10, wherein the calculation unit is arranged in an engine control unit.

12. The computer program of claim 10, wherein the method includes decrementing the counter upon occurrence of the interrupt.

13. The computer program of claim 10, wherein the method includes initializing the counter at specific points in time.

14. The computer program of claim 10, wherein the method includes:
enabling the interrupt and initializing the counter;
upon occurrence of the interrupt, decrementing the counter; and
inhibiting the interrupt as soon as the counter is equal to zero.

15. A computer program product comprising program code stored on a computer-readable data medium, the program code executable by one of a computer and a corresponding calculation unit, the program code configured to perform a method for processing interrupt signals, the method including:
modifying, upon occurrence of an interrupt, a status of a counter in predetermined fashion; and
inhibiting the interrupt as soon as the status of the counter assumes a definable value.

16. The computer program product of claim 15, wherein the calculation unit is arranged in an engine control unit.

17. The computer program product of claim 15, wherein the method includes decrementing the counter upon occurrence of the interrupt.

18. The computer program product of claim 15, wherein the method includes initializing the counter at specific points in time.

19. The computer program product of claim 15, wherein the method includes:
enabling the interrupt and initializing the counter;
upon occurrence of the interrupt, decrementing the counter; and
inhibiting the interrupt as soon as the counter is equal to zero.

20. The computer program product of claim 15, wherein the calculation unit is arranged in an engine control unit.
